(19) United States
(12) Patent Application Publication
(10) Pub. No.: US 2008/0261591 A1
(43) Pub. Date: Oct. 23, 2008

(54) Method for Transmitting Application-Specific Registration or De-Registration Data and System, Server and Communication Terminal Therefor

(75) Inventors: Josef Laumen, Munich (DE); Andreas Schmidt, Braunschweig (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Munich (DE)

(21) Appl. No.: 11/573,158

(22) PCT Filed: Jul. 6, 2005
(86) PCT No.: PCT/EP05/07306

§ 371 Date: Sep. 14, 2007

(30) Foreign Application Priority Data
Aug. 2, 2004 (DE) 10 2004 037 338.8

(51) Int. Cl. H04Q 7/20

(52) U.S. Cl. 455/435.1

(57) ABSTRACT

A communication system having a communication terminal and a server, wherein the communication terminal has a signaling device which is configured to transmit to the server an information element which specifies whether at least one application installed on the communication terminal uses Multimedia Messaging Service as a transport medium for transmission of data, and wherein the server has a control device which is configured to carry out a control action as a function of the transmitted information element.

### CROSS-REFERENCE TO RELATED APPLICATION

This application is a US National Stage of International Patent Application Serial No. PCT/EP2005/007306, filed Jul. 6, 2005, which published in German on Feb. 16, 2006, as WO/2006/015672, and is incorporated herein by reference in its entirety.

### BACKGROUND OF THE INVENTION

The invention relates to a communication system, to a method for controlling a communication system, to a server, to a method for operation of a server, to a communication terminal and to a method for operation of a communication terminal.

Mobile radio communication systems based on the GSM (Global System for Mobile Communications) Standard allow not only voice communication links but also the transmission and reception of text messages with a length of up to 160 characters, by means of the SMS (Short Message Service).

One possible successor to this simple and generally successful communication service is the MMS (Multimedia Messaging Service) which, for example, is described in 3GPP TS 22.140 version 6.5.0, Release 6; Third Generation Partnership Project; Technical Specification Group Services and System Aspects; Multimedia Messaging Service (MMS); Service Aspects (Stage 1), and 3GPP TS 23.140 version 6.5.0, Release 6; Third Generation Partnership Project; Technical Specification Group Terminals; Multimedia Messaging Service (MMS); Functional Description (Stage 2).

MMS is a communication service which allows the mobile transmission and the mobile reception of messages with multimedia contents. A message transmitted by means of the MMS is referred to in the following text as a multimedia message (MM).

In contrast to SMS, the content of MMS transmitted messages is not restricted to a text length of 160 characters.

A multimedia message may have a plurality of multimedia elements, that is to say multimedia files, different file types (for example audio files or still image files) and different file formats (for example GIF or JPEG in the case of a still image file).

MMS also allows the transmission of relatively small multimedia presentations with a fixed time and/or spatial sequence.

At the request of operators of GSM communication systems, that is to say mobile radio communication systems according to the GSM Standard, MMS message classes have been defined for Version 1.2 of the MMS, which will be introduced to the market in the near future, for example as described in OMA-MMS-CONF-v1_{—}2-20030929-C; Open Mobile Alliance; MMS Conformance Document 1.2; Candidate Version 16 Sep. 2003.

The maximum amount of data which the multimedia message may contain is fixed for a multimedia message in a specific MMS message class. Furthermore, the file types and file formats that may be used for multimedia elements are fixed, in order that the multimedia message may contain these multimedia elements.

File formats are typically specified by means of MIME (Multi Purpose Intermail Extensions) Content Types, as described in RFC2045; Multipurpose Internet Mail Extensions (MIME), Part One: “Format of Internet Message Bodies”; November 1996; (http://www.ietf.org/rfc/rfc2045.txt).

On the initiative of the JAVA Community, in particular the JSR-205 Expert Group (see for example http://wwwjcp.org/en/home/index), work has been carried out under the heading “Application Addressing Scheme” within the 3GPP (3rd Generation Partnership Project), with the aim of extending the communication protocol used for MMS, so MMS can be used by applications, that is to say software applications, as a transport medium (carrier), that is to say files and data which are transmitted within an application can be transmitted by means of MMS.

This will supposedly make it possible for applications within which data is transmitted by means of MMS to be installed both on a network element in a mobile radio network and on a mobile communication terminal.

In order to allow the data transmission carried out within an application by means of MMS, the addressing of applications will supposedly be possible in the case of MMS, that is to say a multimedia message can be transmitted with the statement of an application address which is addressed as an application, and/or of an application identifier, which identifies an application, from a sender to the addressed or identified application.

As soon as this is the case, files with file types or file formats which until now it has not been possible to transmit by means of MMS will supposedly be transmitted by means of MMS, supposedly because a large number of applications installed on mobile communication terminals will receive and/or transmit data of application-specific MIME content types.

A large number of files will accordingly supposedly be transmitted by means of MMS, having file types and file formats which will be used by an application installed on a communication terminal, but which are not “normally” supported by the communication terminal, that is to say cannot be used, if the application is not installed on that communication terminal.

A conventional MMS relay/server according to the MMS Standard cannot distinguish whether a multimedia message to be transmitted is a multimedia message which contains a file with a file type or file format which can be used by a communication terminal, that is to say processed, that is to say for example can be displayed on the screen of the communication terminal, or whether the multimedia message is used as a transport container and contains a file with a file type and/or a file format which is specifically intended for an application installed on the communication terminal, and which can be processed by the communication terminal only by means of this application.

In particular, it is possible for an MMS relay/server to delete the content of a multimedia message, on the assumption that the content of the multimedia message cannot be processed by the communication terminal, in the course of a so-called content adaptation process based on the information that it knows about a communication terminal, even though the content can be processed by at least one application which is installed on that communication terminal.

The information that the communication terminal cannot process files of a specific file type can be known to an MMS relay/server in the course of a so-called UA Prof (User Agent Profile) of the communication terminal, which is a profile of the communication terminal, and, as part of its capability to adapt the contents of multimedia messages to the capability and characteristics of communication terminals, the MMS relay/server could delete files of this file type in multimedia messages since the MMS relay/server does not know that an application which can process these contents is installed on that communication terminal.

This can result in considerable quality losses and data losses.

This behavior of the MMS relay/server is particularly disadvantageous when the user of the communication terminal incurs costs for the transmission of multimedia messages because, for example, he is a subscriber to a value added service provider (VASP) using MMS as the transport medium.

At the moment, there are a large number of MMS providers who do not yet make use of the capability for content adaptation. However, this will supposedly change with the introduction of MMS Version 1.2 in the near future.

The minimum requirements and guidelines for the interaction between MMS mobile telephones and MMS servers are specified in document OMA-MMS-CONF-v112-20030929-C; Open Mobile Alliance; MMS Conformance Document 1.2; Candidate Version 16 Sep. 2003.

The various headers which are used to describe the structure of MIME (Multi Purpose Internet Mail Extensions) messages are specified in RFC2045; Multipurpose Internet Mail Extensions (MIME), Part One: “Format of Internet Message Bodies”; November 1996; (http://www.ietf.org/rfc/rfc2045.txt).

The UA-Prof (User Agent Profile) is specified in OMA-WAP-UAProf-v1_{—}1-20021212-C; Open Mobile Alliance; User Agent Profile 1.1; Candidate Version 12-12-2002; (http://member.openmobilealliance.org). UA-Prof has been standardized by the WAP (Wireless Application Protocol) Forum in order that information about the characteristics of a communication terminal, for example a mobile communication terminal, can be signaled to a server in a communication system. The characteristics of a mobile communication terminal, that is to say of a mobile radio communication terminal, in a mobile radio system can obviously be made known at the network end in this way. UA-Prof, which was originally developed for mobile browsers for the Internet, is currently also being used for other mobile communication services, that is to say mobile radio communication services, for example MMS.

The UA-Prof Standard is currently being developed further by the OMA (Open Mobile Alliance).

UA-Prof can also be used to signal additional characteristics of further components in a communication system to a server, for example a WAP gateway which is coupled between the server and a communication terminal and can handle, and in the process change, the data being transferred between the server and the communication terminal.

According to the prior art, a so-called resultant profile is transmitted to the server for this purpose. However, the server does not know whether the information contained in the resultant profile specifies characteristics of the further components or of the communication terminal, but, clearly, all of the specified characteristics of the transmission chain between the communication terminal and the server will be considered as characteristics of the communication terminal, so that the transmitted resultant profile will be interpreted as a profile of the communication terminal.

Extensible Markup Language (XML) 1.1; W3C Recommendation, 4 Feb. 2004, François Yergeau, John Cowan, Tim Bray, Jean Paoli, et. al.; (http://www.w3.org/XML) describes the XML (Extensible Markup Language).

OMA-MMS-CTR-v1_{—}2-20030916-C; Open Mobile Alliance, MMS Client Transactions 1.2; Candidate Version 16 Sep. 2003; (http://member.openmobilealliance.org) describes the interchange of MMS Protocol Data Units (PDUs) between a terminal and a network unit.

RFC1766; Tags for the Identification of Languages; March 1995; (http://www.ietf.org/rfc/rfc1766.txt) describes a language tag for use in situations in which it is desirable to indicate the language which is being used for an information object.

3GPP TS 26.234 version 5.4.0, Release 5, Third Generation Partnership Project; Transparent end-to-end Packet Switched Streaming Service (PSS); Protocols and Codecs is a document from 3GPP, in which protocols and codecs are specified for the packet-switched streaming service (PSS).

US 2001/0047517 A1 discloses a method and an apparatus for intelligent transcoding, (that is to say conversion, of multimedia data between two network elements, with transcoding information being stored and transmitted.

US 2003/177269 A1 discloses an apparatus and a method for the transmission of information by means of a communication link to a client, with the information being converted to a format on the basis of the characteristics of the client and of the communication link, and being transmitted using this format.

EP 1 091 601 A2 discloses a method for the transmission of a message with a specific content to a terminal, in which case a specific application service center uses a short message to inform the terminal of the nature of the message, and the specific application service center sends the message to the terminal or for example to a website, depending on the reaction of the terminal, for subsequent access by means of a password.

EP 1 263 205 A1 discloses a method for provision of signals for a coded still image to a terminal, with a network element in a communication system receiving the signals, at least partially converting them, and sending them to the terminal.

US 2003/0177269 A1 describes a communication system in which a client unit transfers its data processing capability, for example the characteristics of the display unit of the client unit or else possible characteristics of a loudspeaker or in general of the data formats which can in each case be processed, to a data formatting unit. Multimedia data is converted on a client-specific basis by the formatting unit, in terms of the client characteristics, and is then transmitted to the respective client unit.

### BRIEF DESCRIPTION OF THE DRAWINGS

Exemplary embodiments of the invention will be explained in more detail in the following text, and are illustrated in the figures, in which:

FIG. 1 shows a communication system according to one exemplary embodiment of the invention.

FIG. 2 shows a message flowchart according to one exemplary embodiment of the invention.

FIG. 3 shows a message flowchart according to one exemplary embodiment of the invention.

FIG. 4 shows a message flowchart according to one exemplary embodiment of the invention.

### DETAILED DESCRIPTION OF THE INVENTION

The invention is based on the problem of making it possible to use MMS as a transport medium for an application which is installed on a communication terminal.

The problem is solved by a method for control of a communication system, by a server, by a method for operation of a server, by a communication terminal and by a method for operation of a communication terminal, having the features of the independent patent claims.

A communication system having a communication terminal and a server is provided, with the communication terminal having a signaling device which is configured to transmit application-specific registration or deregistration data, which is specific for an application installed or deinstalled on the communication terminal, to the server; and the server has a control device which is configured to carry out a control action as a function of the transmitted application-specific registration or deregistration data.

Furthermore, a method for control of a communication system, a server, a method for operation of a server, a communication terminal and a method for operation of a communication terminal on the basis of the communication system described above are provided.

One concept on which the invention is based can clearly be seen in the communication terminal registering an application which is installed on the communication terminal with the server, or deregistering an application which is deinstalled on the communication terminal with the server.

In this context, an application means a software application which is installed on the communication terminal, for example a games application in the course of which data is transmitted in order to allow the game to be played by a plurality of players, or a banking application which, for example, allows the instructions to be actioned securely.

Preferred developments of the invention are specified in the dependent claims. The further refinements of the invention, which are described in conjunction with the communication system, also apply in the same sense to the method for control of a communication system, to the server, to the method for operation of a server, to the communication terminal and to the method for operation of a communication terminal.

It is preferable for the server to have a transmission apparatus which is configured to transmit messages to the communication terminal, and has a conversion device which is configured to convert messages to be transmitted to the communication terminal, and for the control action to be the activation or the deactivation of a conversion by the conversion device of messages to be transmitted by means of the transmission apparatus of the server to the communication terminal.

The server thus clearly preferably has a control unit which is configured to influence the activation or the deactivation of a conversion by the conversion device. The expression “control action” should thus be understood as meaning, for example, the activation or deactivation of a conversion of messages to be transmitted by means of the transmission apparatus of the server to the communication terminal, by the conversion device.

A conversion of a message is, for example, a content adaptation of the message, for example the content adaptation in accordance with MMS, a change to the file type of a file contained in the message, or a change to the file format of a file contained in the message.

The communication terminal clearly signals to the server that no conversion must be carried out for messages which are transmitted to the communication terminal.

The control action preferably also includes the determination of which messages to be transmitted by means of the transmission apparatus of the server to the communication terminal must be converted (partially or entirely) by the conversion device.

The communication terminal can signal which messages should be converted, for example all of the messages sent from one specific sender, all of the messages which contain files of a specific file type and/or file format, or all the messages which are transmitted at a specific time or within a specific time window.

In particular, registration or deregistration of an application may comprise signaling that no conversion or that a conversion must be carried out on messages to be transmitted to the communication terminal, and/or which messages to be transmitted to the communication terminal should be partially or entirely converted.

It is preferable for the conversion device to be configured to convert messages which are to be transmitted to the communication terminal by means of the transmission apparatus using a multimedia transmission protocol.

It is preferable for the signaling device to be configured to transmit the application-specific registration or deregistration data to the server using a multimedia transmission protocol.

The multimedia transmission protocol is preferably the MMS transmission protocol.

A further concept on which the invention is based can be seen in the registration and deregistration of the application being carried out by means of MMS.

If the invention is used for MMS purposes, an MMS relay/server can, for example, be made aware that an application which MMS is using as a transport medium is installed on a communication terminal. This makes it possible, in particular, to avoid undesirable content adaptation of a message to be transmitted to the communication terminal by means of the MMS relay/server, for example the undesirable deletion of a file contained in the message to be transmitted and/or the undesirable conversion of the file type and/or of the file format of a file contained in the message to be transmitted, in the MMS relay/server, temporarily or permanently.

In this case, the server is an MMS relay/server and may identify and provide separate handling for a multimedia message which contains data intended for an application installed on the communication terminal, on the basis of the message header of the multimedia message, in particular on the basis of message header fields which have been inserted specifically for the situation in which applications are being addressed in the multimedia message, and, for example, it can decide as explained above that this is not converted.

Analogously, an MMS user agent which is installed on the communication terminal and is a software program installed on the communication terminal and allows the use of MMS on the basis of the message header of the multimedia message, in particular on the basis of message header fields which have been inserted specifically for the situation in which applications are being addressed in the multimedia message, can identify the application and not present this to the user, for example in the form of a graphics display, but pass them directly to the application.

Alternatively or in addition to this, the MMS relay/server can also indicate to the MMS user agent by means of at least one new message header field in the message header of the multimedia message that the multimedia message should not be presented to the user, for example by being displayed graphically, or it should be passed on directly to the application.

It is preferable for the signaling device to be configured to transmit the application-specific registration or deregistration data in the form of a profile of the communication terminal.

The communication terminal therefore transmits a profile indicating that the communication terminal is able to process messages of a specific type, since an application is installed on the communication terminal and therefore, for example, the server need not convert these messages since, after conversion, it may possibly no longer be possible for them to be used by the application, resulting in loss of data.

The profile preferably complies with the UA-Prof Standard, as described in OMA-WAP-UAProf-v1_{—}1-20021212-C; Open Mobile Alliance; User Agent Profile 1.1; Candidate Version 12-12-2002; (http://member.openmobilealliance.org).

A further concept on which the invention is based may comprise registration of an application which is installed on the communication terminal or on some other unit in the communication system, for example an MMS relay/server, for the unit on which the application is installed.

In one embodiment, which is described in the following text, this registration process comprises notification to the unit on which the application is installed (or the negotiation between the unit on which the application is installed and the application) of an application identification and/or an application address for the application, and possibly the transfer of additional information in the form of values of additional parameters from the application to the unit on which the application is installed. This additional information is used to control the bidirectional data interchange between the application and the unit on which the application is installed, for example when the application wishes to send (payload) data via MMS, or the unit wishes to pass on (payload) data received via MMS to the application.

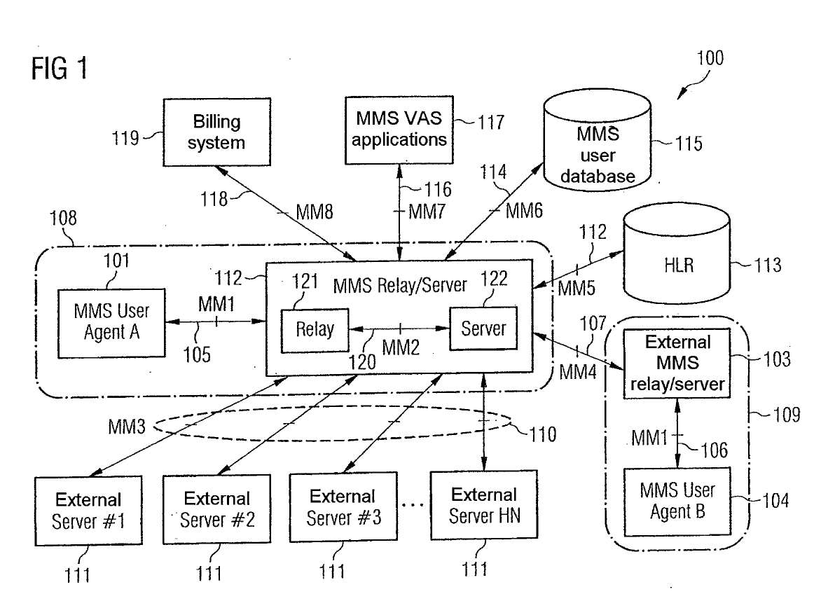

FIG. 1 shows a communication system 100 according to one exemplary embodiment of the invention.

The communication system 100 is designed on the basis of the MMS communication network architecture specified within the 3GPP.

A first MMS user agent 101 is coupled to a second MMS user agent 104 by means of a first MMS relay/server 102 and a second MMS relay/server 103.

An MMS user agent 101, 104 is a software program which is provided, for example, on a mobile radio subscriber appliance, on an appliance connected to a mobile radio subscriber appliance, for example on a laptop or on some other communication terminal, and provides MMS, that is to say allows the use of MMS.

The first MMS user agent 101 is coupled to the first MMS relay/server 102 by means of a first interface 105, which is annotated MM1.

The second MMS user agent 104 is coupled to the second MMS relay/server 103 by means of a second interface 106, which is likewise annotated MM1.

The first MMS relay/server 102 is coupled to the second MMS relay/server 103 by means of a third interface 107, which is annotated MM4.

The first MMS relay/server 102 is located in a first responsibility area (Multimedia Messaging Service Environment, MMSE) 108 of a first MMS service provider (MMS provider), and the second MMS relay/server 103 is located in a second responsibility area 109 of a second MMS service provider.

An MMS relay/server 102, 104 is a network element which provides the communication service MMS in the responsibility area 108, 109 of an MMS service provider to those MMS user agents which are located in the responsibility area 108, 109, that is to say which are provided on communication terminals which are located in the responsibility area.

The first MMS user agent 101 is located in the first responsibility area 108, and the second MMS user agent 104 is located in the second responsibility area 109.

An MMS relay/server 102, 104 can adapt contents of a multimedia message to the capabilities and characteristics of a communication terminal, and this is referred to as content adaptation.

By way of example, the first MMS relay/server 102 can delete a file of one file type or of one file format when it has the information that the communication terminal to which a multimedia message which contains this file is being transmitted cannot process files of this file type or of this file format.

Another option for content adaptation is for an MMS relay/server 102, 104 to convert a file in a multimedia message which is being transmitted to a communication terminal or to a user agent which is provided on the communication terminal, that is to say to change the file such that it is of a file type and a file format which can be processed by the communication terminal. This conversion process is also referred to as transcoding.

In this embodiment, the information about the capabilities and characteristics of the communication terminal which has the first MMS user agent 101 and about the second communication terminal which has the second MMS user agent 104 is respectively available to the first MMS relay/server 102 and to the second MMS relay/server 103 in the form of a communication terminal profile for the communication terminal in each case, which is designed in accordance with the UA Prof (User Agent Profile) Standard described below.

Further servers 111 are coupled to the first MMS relay/server 102 by means of a fourth interface 110, which is annotated MM3. The further servers 111 are external servers which, for example, provide e-mail communication services, fax communication services or UMS (Unified Messaging) communication services.

From the point of view of the first MMS relay/server 102, the second MMS relay/server 103 is operated by an external MMS service provider.

The second interface 107 can thus be regarded as a means for linking external MMS service providers.

An HLR (Home Location Register) 113 is coupled to the first MMS relay/server 102 by means of a fifth interface 112, which is annotated MM5.

The HLR 113 is a part of a mobile radio communication system by means of which the first MMS relay/server 102 communicates with the first MMS user agent 101, that is to say that the first interface 105 is provided by means of the mobile radio communication system.

The first MMS user agent 101 is implemented on a subscriber appliance in the mobile radio communication system, with this mobile radio communication system having the HLR 113.

The mobile radio communication system is, for example, designed in accordance with the GSM Standard or the UMTS (Universal Mobile Telecommunications System) Standard.

The individual customer data for the user of the communication terminal on which the first MMS user agent 101 is implemented and embodied is stored in the HLR 113. The HLR 113 is typically located in the responsibility area of the mobile radio communication system, and this need not be identical to the first responsibility area 108 or to the second responsibility area 109.

One (or more) MMS user database (or bases) 115 is (or are) coupled to the first MMS relay/server 102 by means of a sixth interface 114, which is annotated MM6.

A value added service (VAS) server 117 for a value added service provider (VASP) is coupled to the first MMS relay/server 102 by means of a seventh interface 116, which is annotated MM7.

Value added services (VAS) are provided by means of the value added service server 117 to the user of the first MMS user agent 101, and possibly to further users of the MMS which is provided by means of the first MMS relay/server 102. A value added service is a communication service which goes beyond the pure provision of a communication link, for example the transmission of share price or telephone number information.

A billing system 119, which is used to gather and evaluate all of the relevant information for charging for the MMS, is coupled to the first MMS relay/server 102 by means of an eighth interface 118, which is annotated MM8.

A ninth interface 120, which couples the relay element 121 of the first MMS relay/server 102 and the server element 122 of the first MMS relay/server 102, is annotated MM2.

The communication system 100 may have further interfaces.

Interfaces with the designations MM9 and MM10 are currently being discussed in the standardization committees.

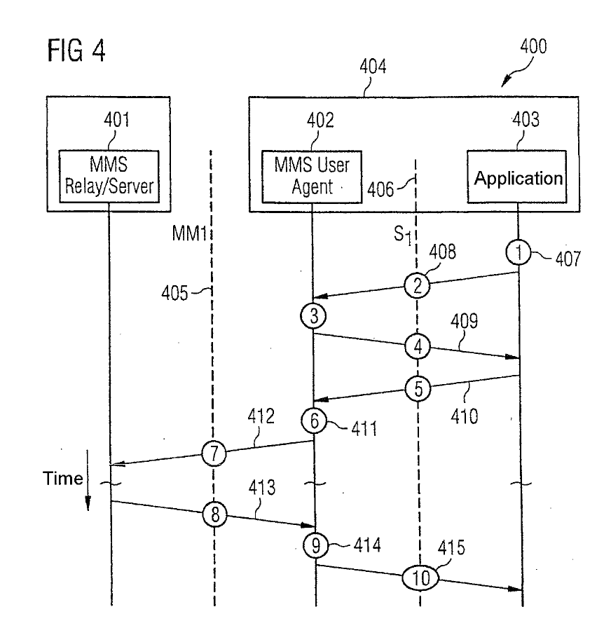

FIG. 2 shows a message flowchart 200 according to one exemplary embodiment of the invention.

The message flow illustrated in FIG. 2 takes place between a first MMS user agent 201, a first MMS relay/server 202, a second MMS relay/server 203 and a second MMS user agent 204, which are arranged and designed as described above with reference to FIG. 1.

The message flow illustrated in FIG. 2 is carried out by means of a first interface 205, a second interface 206 and a third interface 207, which are arranged and designed as described with reference to FIG. 1.

The message flowchart 200 illustrates the message flow and the data interchange between the MMS user agents 201, 204 and the MMS relay/servers 202, 204 during a transmission of a multimedia message 208. The message flow illustrated in the message flowchart 200 is configured on the basis of the 3GPP transaction flowchart, as is described by way of example in 3GPP TS 23.140 version 6.5.0, Release 6; Third Generation Partnership Project; Technical Specification Group Terminals; Multimedia Messaging Service (MMS); Functional Description (Stage 2).

In particular, the messages transmitted in the course of the described message flow are configured in accordance with the 3GPP abstract messages as defined in 3GPP TS 23.140 version 6.5.0, Release 6; Third Generation Partnership Project; Technical Specification Group Terminals; Multimedia Messaging Service (MMS); Functional Description (Stage 2).

The messages transmitted in the course of the illustrated message flow each have at least one message header field (information element). In step 209, the first MMS user agent 201, which is the sender of the multimedia message 208, uses the first interface 205 which, for example, is an air interface to send the multimedia message 208 to the first MMS relay/server 202 by means of an MM1_submit.REQ message.

In step 210, the first MMS relay/server 202 confirms correct reception of the multimedia message 208 from the first MMS user agent 201 by means of an MM1_submit.RES message.

Analogously to step 209, in step 211, the multimedia message 208 is transmitted from the first MMS relay/server 202 to the second MMS relay/server 203 by means of an MM4_forward.REQ message, and to the second interface 206, and correct reception of the multimedia message 208 is confirmed in step 212 by the second MMS relay/server 203 by means of an MM4_forward.RES message and the second interface 206.

The second MMS user agent 204, which is the recipient of the multimedia message 208, is informed in step 213, by means of an MM1_notification.REQ message and the third interface 207, that the multimedia message 208 is available for downloading.

The MM1_notification.REQ message contains a reference to the memory location of the multimedia message 208 in the responsibility area (MMSE) to which the second MMS relay/server 203 belongs, in the form of a URI (Uniform Resource Identifier).

In step 214, the correct reception of the MM1_notification.REQ message is confirmed by the second MMS user agent 204 by means of an MM1_notification.RES message and the third interface 207.

In step 215, the second MMS user agent 204 uses an MM1_retrieve.REQ message and the third interface 207 to initiate downloading of the multimedia message 208 provided in the second MMS relay/server 203.

In step 216, the multimedia message 208 is passed from the second MMS relay/server 203 to the second MMS user agent 204 by means of an MM1_retrieve.RES message and the third interface 207.

In step 217, the second MMS user agent 204 informs the second MMS relay/server 203 by means of an MM1_acknowledgement.REQ message and the third interface 207 that the multimedia message 208 which was provided in step 216 has been output, that is to say about the output for downloading of the multimedia message 208.

Further messages can also be interchanged in accordance with the MMS Standard.

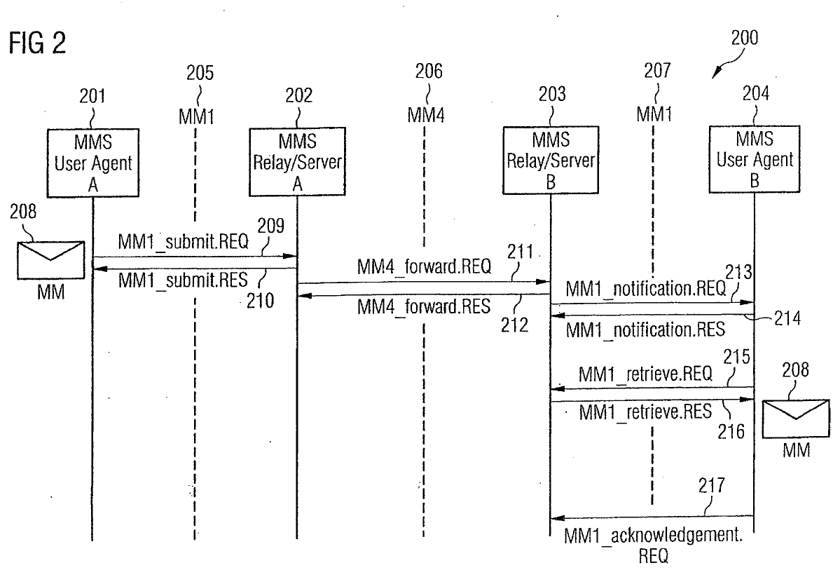

FIG. 3 shows a message flowchart 300 according to one exemplary embodiment of the invention.

The message flow illustrated in FIG. 3 takes place between a communication terminal 301, a gateway computer 302 and a server 303.

By way of example, the communication terminal 301 is a subscriber appliance in a mobile radio communication system in which subscriber appliance the first MMS user agent 101 is implemented, as described above with reference to FIG. 1.

The server 303 is, for example, the first MMS relay/server 102, which has been described above with reference to FIG. 1.

The gateway computer 302 is, for example, a gateway computer by means of which data is transmitted between the communication terminal 301 and the server 303, for example by being part of the first interface 105, which has been described above with reference to FIG. 1 (corresponding to the third interface 207 in FIG. 2).

By way of example, the gateway computer 302 is a wireless application protocol (WAP) gateway computer.

Computer terminals such as the communication terminal 301 typically differ from one another in terms of their characteristics and capabilities. For example, the characteristics of the display apparatuses of the communication terminals may differ in terms of the display size, the range of colors and the resolution of the display apparatuses, or the capabilities of the communication terminals to display and/or process files of a specific file type and/or file format.

The message flow illustrated in FIG. 3 is used to transmit information about the capabilities and characteristics of the communication terminal 301 to the server 303.

This is done using a communication terminal profile which is configured in accordance with the UA Prof (User Agent Profile), which has been standardized by the WAP (Wireless Application Protocol) forum.

Furthermore, the message flow is also used to signal to the server 303 the capabilities of the gateway 302 which handles the data being transferred between the server 303 and the communication terminal 301, and which may also change.

The following text refers to FIG. 3 in order to describe how the current communication terminal profile of the communication terminal 301 is signaled to the server 303.

In step 304, a basic profile BP of the communication terminal 301 or a reference to a basic profile BP for the communication terminal 301 is transmitted by means of a first message 313 to the gateway computer 302, for example during registration of the communication terminal 301 with the server 303 or when setting up a communication link between the communication terminal 301 and the server 303.

If the characteristics and/or the capabilities of the communication terminal 301 which are specified by means of the basic profile BP have been changed or extended, for example as a result of additional hardware being connected, the first message 313 is updated by also transmitting a first difference profile DP1 for the communication terminal 301 or a reference to a first difference profile DP1 for the communication terminal 301 to the gateway computer 302 by means of the first message 313 in step 304, in addition to the basic profile BP.

This example assumes that a first difference profile DP1 is transmitted.

The basic profile BP and the first difference profile DP1 can be temporarily stored and evaluated by the gateway computer 302 in step 305. The gateway computer 302 can add a second difference profile DP2, which is produced by the gateway computer 302 itself, to the basic profile BP and the first difference profile DP1. This is done, for example, when the gateway computer 302 has special characteristics and/or capabilities which differ from or complement characteristics and capabilities of the communication terminal 301 as specified by means of the basic profile BP and the first difference profile DP1.

This example assumes that a second difference profile DP2 is produced.

The basic profile BP, the first difference profile DP1 and the second difference profile DP2 are transmitted to the server 303 by means of a second message 314 in step 306.

In step 307, the server 303 uses the basic profile BP, the first difference profile DP1 and the second difference profile DP2 as the basis to produce a resultant profile for the communication terminal 301. If only references to profiles, instead of the profiles themselves, that is to say of the first basic profile BP or of the first difference profile DP1 or of the second difference profile DP2, have been transmitted in step 304 or in step 306, it may be necessary to dereference before the processing in step 305 by the gateway computer 302 and/or before the processing 307 by the server 303, that is to say the referenced profile may need to be downloaded from other servers in which they are stored.

The resultant profile, which specifies the individual characteristics of the communication terminal 301, which in this exemplary embodiment is WAP-compatible, and, if appropriate, the supplementary capabilities of the gateway 302 and/or of any other network element, represents the current communication terminal profile, and is managed by the server 303.

While a communication link or a communication session is in existence, the downloading of data can be initiated by the communication terminal 301 by sending a data request message. In step 308, the communication terminal 301 transmits a data request message 315 such as this to the gateway computer 302. This example assumes that the characteristics or capabilities of the communication terminal 301 have changed since step 304. The data request message 315 is therefore used to transmit an updated basic profile BP and a third difference profile DP3 to the gateway computer 302. Steps 310, 311 and 312 which are then carried out are carried out analogously to steps 305, 306 and 307.

If characteristics and capabilities of the communication terminal 301 have not changed since step 304, then no updated basic profile BP and no third difference profile DP3 are transmitted in step 308, and the steps which follow step 308 are based on the use of the profiles of the communication terminal 301 as transmitted in steps 304 to 307 and stored in the gateway computer 302 and/or in the server 303, for example the already determined resultant profile. If the profile which is stored in the gateway computer 302 has likewise not changed since step 304, then the server 303 uses the profile of the communication terminal 301 as transmitted in steps 304 to 307.

A resultant profile comprising a basic profile and any desired number of difference profiles is thus generated in the procedure explained with reference to FIG. 3, in which case the data can also be transmitted between the communication terminal 301 and the gateway computer 302 in the form of references to the basic profile and to any difference profiles. The volume of data to be transmitted by means of the air interface for the current communication terminal profile is furthermore minimized because an updated basic profile and/or difference profile need be transmitted only following a change in the characteristics and/or capabilities of the communication terminal 301.

According to OMA-WAP-UAProf-v1_{—}1-20021212-C; Open Mobile Alliance; User Agent Profile 1.1; Candidate Version 12-12-2002; (http://member.openmobilealliance.org), the transmitted profiles, that is to say the basic profiles and the difference profiles, are configured on the basis of the metalanguage XML (Extensible Markup Language), which is described by way of example in Extensible Markup Language (XML) 1.1; W3C Recommendation, 4 Feb. 2004, François Yergeau, John Cowan, Tim Bray, Jean Paoli, et. al.; (http://www.w3.org/XML).

Formats based on XML are highly suitable for interchanging structure data in a manner that is independent of the platform and independent of the software. This applies in particular to the data transfer between programs and computers of different manufacturers and systems.

A plurality of components can be specified by means of one communication terminal profile, in which case each component may have a plurality of attributes with the associated values. For example, the hardware component attributes are, for example, the screen size, the color capability, and their values.

The profiles (basic profiles BP and difference profiles DP1, DP2, DP3) transmitted in the message flow illustrated in FIG. 3, and the resultant profile, are configured, for example, as shown in Table 1, which shows the basic structure of a profile, as defined by the WAP Forum for the UA-Prof Standard in OMA-WAP-UAProf-v1_{—}1-20021212-C; Open Mobile Alliance; User Agent Profile 1.1; Candidate Version 12-12-2002; (http://member.openmobilealliance.org).

TABLE 1

Component_1
Attribute_1a = Value_1a
Attribute_1b = Value_1b
Component_2
Attribute_2a = Value_2a
Attribute_2b = Value_2b
Attribute_2c = Value_2c
Attribute_2d = Value_2d

Information blocks and individual information items within a profile are delineated from one another by means of so-called tags (marks).

In the case of XML-based documents, most tags occur in pairs as start commands and end commands, and indicate the meaning of the text enclosed between them. The enclosed text may itself be subdivided by means of further tags, so that, for example, lists of parameters can be produced for one attribute. The details relating to attribute in an XML-based file are always enclosed by quotation marks (< >).

This type of subdivision has the advantages that all of the components and attributes can be used and extended flexibly. Furthermore, this allows the structure of a profile based on the UA-Prof Standard to be extended as required, and allows simple graphics display.

The data request message 315 transmitted in step 308 is, for example, the MM1_retrieve.REQ message as described with reference to FIG. 2 and transmitted in step 215.

This message is produced at the transport protocol level, for example by means of the data request command “WSP GET” in the transport protocol WSP (Wireless Session Protocol) that is used for MMS or the data request command “http GET” in accordance with the http (Hypertext Transfer Protocol) transport protocol that is used for MMS.

In this exemplary embodiment, and corresponding to step 308, the respective data request command contains a basic profile and one or more difference profiles.

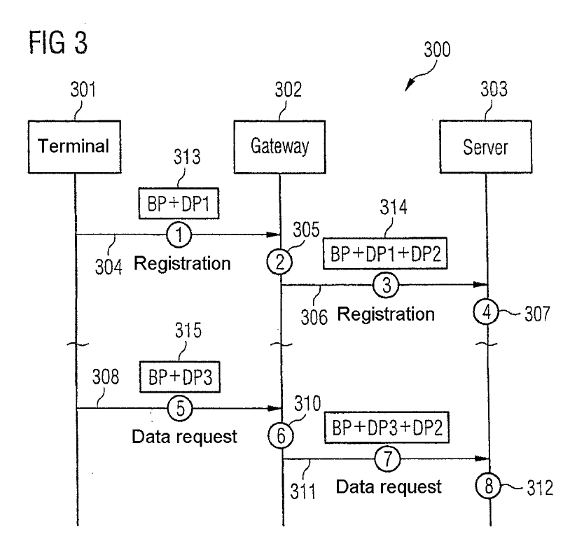

FIG. 4 shows a message flowchart 400 according to one exemplary embodiment of the invention.

The message flow illustrated in FIG. 4 takes place between an MMS relay/server 401, an MMS user agent 402 and an application 403.

The MMS user agent 402 and the application 403 are installed on a communication terminal 404. By way of example, the communication terminal 404 is a subscriber appliance in a mobile radio communication system.

The MMS relay/server is, for example, arranged and configured analogously to the first MMS relay/server 102, which has been described above with reference to FIG. 1.

The MMS user agent 402 is, for example, arranged and configured analogously to the first MMS user agent 101, which has been described above with reference to FIG. 1.

The message flow is carried out by means of a first interface 405, which is configured analogously to the first interface 105 (or the third interface 207), which has been described above with reference to FIG. 1 (or FIG. 2, respectively), and a second interface 406, which forms the interface between the MMS user agent 402 and the application 403.

In order to use MMS as a transport medium, after successful installation of an application on a communication terminal or in general on an MMS unit, for example an MMS relay/server or a VASP server, the MMS unit allocates an application identification for that application, which identifies the application, and/or an application address, by means of which the application can be addressed, or the application signals to the MMS unit an application identification for the application and/or an application address for the application.

If possible, the application identification and/or the application address which are used for referencing of the application and are used in particular for sending multimedia messages, indicating the application identification of the application and/or the application address of the application, to the application, are chosen uniquely.

In one embodiment and if required, a unique application identification and/or application address for the application are/is negotiated between the application and the MMS unit.

In one embodiment, the application identification and/or application address contain a hierarchically subdivided URI (Uniform Resource Identifier; reference to a memory location), in order to always still ensure second manual or automatic resolution, for example by means of a different application, in the possible event of failure of automatic resolution of the application identification and/or application address by the addressed MMS unit.

In a further embodiment, the application identification and/or application address differs by at least one specific element (preferably by the last element or elements) in the hierarchical subdivision, so that, for example, the addressing of different instances for the same application is ensured by resolution of this specific element or these specific elements.

In this embodiment, the application 403 preferably signals to the MMS unit, that is to say in this case the MMS user agent 402, an application identification and/or application address, which is known to the application 403, to the application 403, since in this way senders which transmit to the communication terminal 404 a multimedia message by means of which data is transmitted to the application 403 can use the application identification and/or the application address that is known by the application 403, and need not be informed about an application identification and/or application address which has been allocated to the application 403 by the MMS unit or has been negotiated by the MMS unit and the application 403.

In another embodiment, the MMS unit manages the allocation of an external identification (that is to say a second application identification and/or application address), which is used for addressing of an application on the first interface 405, to the internally negotiated application identification and/or application address which is used for addressing on the second interface 406. However, this embodiment involves more complexity than the embodiment described above.

It is assumed that, in step 407, the application 403 has been successfully installed on the communication terminal 404.

In step 408, the application 403 notifies the MMS user agent 402, by means of an appropriate message, of the application identification allocated to it, and/or of the application address allocated to it.

Steps 409 and 410 are carried out optionally, for example being carried out or not carried out depending on the application 403 and the communication terminal 404.

In step 409, the MMS user agent 402 requests the application 403 to transmit additional information, which the application 403 transmits to the MMS user agent 402 in step 410.

By way of example, in step 410 (or even in step 408), the application 403 could transmit the information to the MMS user agent 402 that the MMS user agent 402, on reception of an MM1_notification.REQ message by the MMS User Agent 402, should transmit the content of the message header fields of the MM1_notification.REQ message, which specify the sender address of the MM1_notification.REQ message and the reference of the MM1_notification.REQ message, to the application 403, or transmit to the MMS user agent the information that the MMS user agent 402 should automatically request a transmission report (delivery report) for the MM1_submit.REQ message if it sends a multimedia message by means of an MM1_submit.REQ message within the application 403. In general, the application in the MMS unit on which it is installed uses the interchange of additional information in step 410 (or even in step 408) as described above to indicate what data it intends to transmit in what format (if the application initiates the sending of a 3GPP abstract message, as defined in 3GPP TS 23.140 version 6.5.0, Release 6; Third Generation Partnership Project; Technical Specification Group Terminals; Multimedia Messaging Service (MMS); Functional Description (Stage 2), from the MMS unit) or what data it intends to receive in what format (if the application receives the data from the MMS unit from a received 3GPP abstract message as defined in 3GPP TS 23.140 version 6.5.0, Release 6; Third Generation Partnership Project; Technical Specification Group Terminals; Multimedia Messaging Service (MMS); Functional Description (Stage 2)).

The additional information transmitted from the application 403 to the MMS user agent may also include a difference profile in accordance with the UA Prof Standard with information about the application 403, that is to say a difference profile for the application 403, which is transmitted to the MMS relay/server 401 in step 411.

The transmission of difference profiles for applications overcomes the problem of undesirable content adaptation but only if all of the applications which transmit data by means of MMS produce difference profiles. It is therefore not preferable for difference profiles for applications to be transmitted within the transmitted additional information.

Steps 411 and 412 are carried out differently, depending on the embodiment, in particular depending on whether steps 409 and 410 have been carried out.

In one embodiment, the MMS user agent 402 uses a corresponding message produced in step 412 to inform the MMS relay/server 401, in step 412, that a new application 403, which uses MMS as the transport medium, has been installed on the communication terminal 404. This can be done, for example, by means of a basic profile or by means of a difference profile, depending on the time at which the application 403 was installed on the communication terminal 404, as has been explained above with reference to FIG. 3.

In one embodiment, the MMS user agent 402 transmits the application identification and/or the application address of the application 403 in step 412, by means of an appropriate message to the MMS relay/server 401.

In one embodiment, the MMS user agent 402 uses a communication terminal profile which has been upgraded in comparison to OMA-MMS-CONF-v1_{—}2-20030929-C; Open Mobile Alliance; MMS Conformance Document 1.2; Candidate Version 16 Sep. 2003, and is compliant with the UA Prof Standard which transmits the profile of the MMS user agent 402 to the MMS relay/server 401 to request that the conversion of files for a specific file type and/or a specific file format be temporarily or permanently switched off in the MMS relay/server 401 in the course of the content adaptation in accordance with MMS. In one alternative refinement of the invention, upgrading of this control information is envisaged for transmission of specific constraints from the MMS user agent to the MMS relay/server.

When steps 409 and 410 have been carried out and the transmitted additional information includes a difference profile for the application 403, then this difference profile is evaluated in step 411, and/or is transmitted from the MMS user agent 402 to the MMS relay/server 401 in step 412.

As mentioned above, this procedure allows the problem of undesirable contact adaptation to be solved reliably only when all of the applications reliably support the transmission of information by means of a difference profile in accordance with the UA Prof Standard.

Since it may not be possible to ensure this in practice, the following embodiment is preferable, in which there is no need to transmit a difference profile from the application 403 to the MMS user agent 402.

In step 411, the MMS user agent 402 inserts a first information element into a communication terminal profile, for example into a difference profile in accordance with the UA Prof Standard or into a basic profile for the communication terminal 404 in accordance with the UA Prof Standard, which information element indicates to the MMS relay/server 401 that it should (permanently or temporary) not carry out any conversion of files to be transmitted to the MMS user agent 402 of a specific file type and/or a specific file format. Provision is also made, in one alternative refinement of the invention, for additional constraints (for example in the form of further information elements) to be transmitted from the MMS user agent 402 to the MMS relay/server 401, in order to influence the conversion process.

Examples of a communication terminal profile in accordance with the UA Prof Standard, into which an information element has been inserted, are explained in the following text with reference to Tables 2 to 4.

The first information element may have further supplementary conditions and/or restrictions, for example the information that, from the time of transmission of the first information element to the MMS relay/server 401, the suppression of the conversion of the files which are transmitted to the MMS user agent 402 with a specific file type and/or a specific file format should in general not be carried out, or the information that the conversion of files with a specific file type and/or a specific file format which are transmitted to the MMS user agent 402 should not be carried out only in those situations when the files are used as the transport medium for the application 403 during the course of use of MMS, or the information that the conversion of files with a specific file type and/or file format which are sent to the MMS user agent 402 should not be carried out only when the multimedia messages which contain the files are transmitted from one specific, stated sender to the MMS user agent 402.

In another exemplary embodiment, in which the application 403 has been de-installed from the communication terminal 404, for example in step 407, and the application 403 has logged off from the MMS user agent 402, the MMS user agent 402 inserts a second information element into a difference profile in accordance with the UA Prof Standard in step 411, indicating to the MMS relay/server 401, after transmission of the difference profile to the MMS relay/server 401, that files of a specific file type and/or file format which are transmitted to the MMS user agent 402 should once again be converted from the time of transmission of the second information element.

Once an appropriate communication terminal profile, for example a difference profile in accordance with the UA Prof Standard, has been produced by insertion of a first information element or by the use of the additional information transmitted to the MMS user agent 402 in step 410, has been produced in step 411, the communication terminal profile is transmitted from the communication terminal to the MMS relay/server 401 in step 412.

In one embodiment, in which the application 403 has been de-installed, no second information element is inserted into a difference profile and transmitted, but the first information element as described above is transmitted once again by means of a difference profile in which first information element, however, the value contained in a message header field has been modified in such a way that, after transmission of the first information element, this indicates to the MMS relay/server 401 that files with a specific file type and/or file format which are transmitted to the MMS user agent 402 should (once again) be converted from the time of transmission.

Transmission of the communication terminal profile in step 412 thus results in the MMS relay/server 401 knowing how it should handle multimedia messages transmitted to the communication terminal 404, particularly in the situation in which MMS is used as the transport medium for applications.

By way of example, a multimedia message is transmitted from the MMS relay/server 401 to the MMS user agent 402 in step 413.

If steps 409 and 410 have been carried out, and if additional information has been provided to the NMS user agent 402 in the process specifying that the MMS user agent 402 should handle received multimedia messages in a stated manner, then the MMS user agent 402 does this in step 414.

In step 415, the MMS user agent 402 transmits the data contained in the received multimedia message for the application 403 to the application 403. By way of example, this may be the content of individual message header fields in the multimedia message, or the entire multimedia message.

In one embodiment, the data transmitted in step 415 is dependent on the additional information interchanged in steps 408 and/or 410.

Examples of communication terminal profiles in accordance with the UA Prof Standard into which information elements are inserted in the manner carried out for example in step 411, will be explained in the following text with reference to Table 2, Table 3, Table 4 and Table 5.

TABLE 2

| | | | | |
|---|---|---|---|---|
| Attribute | Description | Resolution rule | Type | Example Value |

Component: MmsCharacteristics

| | | | | |
|---|---|---|---|---|
| MmsMax | Maximum size of the | Closed | Number | 20480 |
| Message | multimedia message in bytes | | | |
| Size | | | | |
| MmsMax | Maximum size of an image | Closed | Literal | “80 × 60” |
| Image | in units of pixels (horizontal × vertical) | | | |
| Resolution | | | | |
| MmsCcpp | List of supported content | Closed | Literal list | “image/jpeg”, |
| Accept | types, transmitted as MIME | | | “audio/wav”, |
| | types | | | “video/mpeg-4” |
| MmsCcpp | List of character sets which | Closed | Literal list | “US-ASCII”, |
| Accept | the MMS client supports. | | | ISO-8859-1” |
| CharSet | Each element in the list is the | | | |
| | name of a character set | | | |
| | which is registered with the | | | |
| | IANA (Internet Assigned | | | |
| | Numbers Authority) | | | |
| MmsCcpp | List of preferred languages. | Closed | Literal list | “en”, |
| Accept | The first element in the list | | | “fr” |
| Language | should be regarded as the | | | |
| | first choice of the user. The | | | |
| | value is a list of natural | | | |
| | languages, with each element | | | |
| | in the list being the name of | | | |
| | a language as defined in | | | |
| | RFC1766; Tags for the | | | |
| | Identification of Languages; | | | |
| | March 1995; | | | |
| | (http://www.ietf.org/rfc/rfc1766.txt) | | | |
| MmsCcpp | List of transfer coding which | Closed | Literal list | “base64”, |
| Accept | the MMS client supports. | | | “quoted |
| Encoding | The value is a list of transfer | | | printable” |
| | codings, with each element | | | |
| | in the list being a transfer | | | |
| | coding name, as specified in | | | |
| | RFC2045; Multipurpose | | | |
| | Internet Mail Extensions | | | |
| | (MIME), Part One: “Format | | | |
| | of Internet Message Bodies”; | | | |
| | November 1996; | | | |
| | (http://www.ietf.org/rfc/rfc2045.txt), | | | |
| | which is registered | | | |
| | with the IANA | | | |
| MmsVersion | MMS versions supported by | Closed | Literal list | “2.0”, “1.3” |
| | the MMS client, transmitted | | | |
| | as | | | |
| | majorVersionNumber.minor | | | |
| | VersionNumber | | | |
| MmsCcpp | Indicates whether the MMS | Closed | Boolean | “Yes”, |
| Streaming | client has a streaming | | | “No” |
| Capable | capability | | | |
| MmsSmilBas | One or more basic sets of | Closed | Literal list | “SMIL-CONF- |
| | SMIL (Synchronized | | | 1-2” |
| | Multimedia Integration | | | |
| | Language) modules which | | | |
| | the client supports. “SMIL- | | | |
| | CONF-1-2” | | | |
| | identifies the SMIL basic set | | | |
| | and associated restrictions, as | | | |
| | defined in | | | |
| | OMA-MMS-CONF-v1_2-20030929- | | | |
| | C; Open Mobile | | | |
| | Alliance; MMS | | | |
| | Conformance Document 1.2; | | | |
| | Candidate Version 16 | | | |
| | Sep. 2003. | | | |
| | Predefined values for basic | | | |
| | sets, as defined in 3GPP TS | | | |
| | 26.234 version 5.4.0, Release | | | |
| | 5, Third Generation | | | |
| | Partnership Project; | | | |
| | Transparent end-to-end | | | |
| | Packet Switched Streaming | | | |
| | Service (PSS); Protocols and | | | |
| | Codecs, may also be used | | | |
| | (for example “SMIL-3GPP- | | | |
| | R4” and “SMIL-3GPP-R5”). | | | |
| MmsContent | List of supported MM | Closed | Literal list | “IX”, “IB”, |
| Class | content classes | | | “IR”, “VB”, |
| | TX = Text | | | “VR” |
| | IB = Image Basic | | | |
| | IR = Image Rich | | | |
| | VB = Video Basis | | | |
| | VR = Video Rich | | | |
| MmsBearer | Indicates whether | Closed | Boolean | “Yes” |
| ForApplic | application/s use(s) MMS | | | “No” |
| | as carrier | | | |
| Mms Suppress | Request for MMS proxy | Closed | Boolean | “Yes”, |
| Content | relay not to carry out content | | | “No” |
| Adaptation | adaptation | | | |

Tables 2 to 5 each show one possible refinement of a communication terminal profile that has been extended in comparison to OMA-MMS-CTR-v1_{—}2-20030916-C; Open Mobile Alliance, MMS Client Transactions 1.2; Candidate Version 16 Sep. 2003; (http://member.openmobilealliance.org).

A communication terminal profile which has been refined according to Table 2 contain an XML attribute, which is new in comparison to OMA-MMS-CTR-v1_{—}2-20030916-C; Open Mobile Alliance, MMS Client Transactions 1.2; Candidate Version 16 Sep. 2003; (http://member.openmobilealliance.org), entitled MmsBearerForApplic which, when the communication terminal profile is being transmitted from a communication terminal to an MMS relay/server, is used to transmit the information that at least one application which uses MMS as the transport medium has been installed on that communication terminal.

In another embodiment, the XML attribute is used to switch content adaptation on and off in the MMS relay/server.

TABLE 3

| | | | | |
|---|---|---|---|---|
| | | | | Example |
| Attribute | Description | Resolution rule | Type | Value |

Component: MmsCharacteristics

| | | | | |
|---|---|---|---|---|
| MmsMax | Maximum size of the multimedia | Closed | Number | 20480 |
| Message Size | message in bytes | | | |
| MmsMax | Maximum size of an image in units | Closed | Literal | “80 × 60” |
| Image | of pixels (horizontal × vertical) | | | |
| solution | | | | |
| MmsCcpp | List of supported content types, | Closed | Literal list | “image/jpeg”, |
| Accept | transmitted as MIME types | | | “audio/wav”, |
| | | | | “video/mpeg- |
| | | | | 4” |
| MmsCcpp | List of content types which are | Closed | Literal | “image/ |
| Accept | supported by the application | | list | new01”, |
| Applic | which uses MMS as carrier | | | “audio/new02”, |
| | | | | “unknown/ |
| | | | | new03” |
| MmsCcpp | List of character sets which the | Closed | Literal list | “US- |
| Accept | MMS client supports. Each element | | | ASCII”, |
| CharSet | in the list is the name of a character | | | “ISO-8859- |
| | set which is registered with the | | | 1” |
| | IANA (Internet Assigned Numbers | | | |
| | Authority) | | | |
| MmsCcpp | List of preferred languages. The first | Closed | Literal list | “en”, |
| Accept | element in the list should be regarded | | | “fr” |
| Language | as the first choice of the user. The | | | |
| | value is a list of natural languages, | | | |
| | with each element in the list being | | | |
| | the name of a language as defined in | | | |
| | RFC1766; Tags for the Identification | | | |
| | of Languages; March 1995; | | | |
| | (http://www.ietf.org/rfc/rfc1766.txt) | | | |
| MmsCcpp | List of transfer coding which the | Closed | Literal | “base64”, |
| Accept | MMS client supports. The value is a | | list | “quoted- |
| Encoding | list of transfer codings, with each | | | printable |
| | element in the list being a transfer | | | |
| | coding name, as specified in | | | |
| | RFC2045; Multipurpose Internet | | | |
| | Mail Extensions (MIME), Part One: | | | |
| | “Format of Internet Message | | | |
| | Bodies”; November 1996; | | | |
| | (http://www.ietf.org/rfc/rfc2045.txt), | | | |
| | which is registered with the IANA | | | |
| MmsVersion | MMS versions supported by the | Closed | Literal list | “2.0”, |
| | MMS client, transmitted as | | | “1.3” |
| | majorVersionNumber.minorVersion | | | |
| | Number | | | |
| MmsCcpp | Indicates whether the MMS client | Closed | Boolean | “Yes”, |
| Streaming | has a streaming capability | | | “No” |
| Capable | | | | |
| MmsSmilBase | One or more basic sets of SMIL | Closed | Literal list | “SMIL- |
| Set | (Synchronized Multimedia | | | CONF-1- |
| | Integration Language) modules | | | 2” |
| | which the client supports. “SMIL- | | | |
| | CONF-1-2” | | | |
| | identifies the SMIL basic set and | | | |
| | associated restrictions, as defined in | | | |
| | OMA-MMS-CONF-v1_2-20030929- | | | |
| | C; Open Mobile Alliance; MMS | | | |
| | Conformance Document 1.2; | | | |
| | Candidate Version 16 Sep. | | | |
| | 2003. | | | |
| | Predefined values for basic sets, as | | | |
| | defined in 3GPP TS 26.234 version | | | |
| | 5.4.0, Release 5, Third Generation | | | |
| | Partnership Project; Transparent | | | |
| | end-to-end Packet Switched | | | |
| | Streaming Service (PSS); Protocols | | | |
| | and Codecs, may also be used (for | | | |
| | example “SMIL-3GPP-R4” and | | | |
| | “SMIL-3GPP-R5”). | | | |
| MmsContent | List of supported MM content | Closed | Literal list | “TX”, “IB”, |
| Class | classes | | | “IR”, |
| | TX = Text | | | “VB”, |
| | IB = Image Basic | | | “VR” |
| | IR = Image Rich | | | |
| | VB = Video Basis | | | |
| | VR = Video Rich | | | |
| Mms | Request for MMS proxy relay not to | Closed | Boolean | “Yes”, |
| Suppress | carry out content adaptation | | | “No” |
| Content | | | | |
| Adaptation | | | | |

In another embodiment, a communication terminal profile configured as shown in Table 3 is used. This communication terminal profile has an XML attribute which is new in comparison to OMA-MMS-CTR-v1_{—}2-20030916-C; Open Mobile Alliance, MMS Client Transactions 1.2; Candidate Version 16 Sep. 2003; (http://member.openmobilealliance.org) entitled MmsCcppAcceptApplic, which is used to transmit information from a communication terminal to an MMS relay/server as to which MIME content types are supported by an application installed on that communication terminal.

TABLE 4

| | | | | |
|---|---|---|---|---|
| | | | | Example |
| Attribute | Description | Resolution rule | Type | Value |

Component: MmsCharacteristics

| | | | | |
|---|---|---|---|---|
| MmsMax | Maximum size of the multimedia | Closed | Number | 20480 |
| Message | message in bytes | | | |
| Size | | | | |
| MmsMax | Maximum size of an image in | Closed | Literal | “80 × 60” |
| Image | units of pixels (horizontal × vertical) | | | |
| Resolution | | | | |
| MmsCcpp | List of supported content types, | Closed | Literal | “image/ |
| Accept | transmitted as MIME types | | list | jpeg”, |
| | | | | “audio/ |
| | | | | wav”, |
| | | | | “video/mpeg |
| | | | | 4” |
| MmsCcpp | List of character sets which the | Closed | Literal | “US-ASCII”, |
| Accept | MMS client supports. Each | | list | “ISO-8859- |
| Charset | element in the list is the name of a | | | 1” |
| | character set which is registered | | | |
| | with the IANA (Internet Assigned | | | |
| | Numbers Authority) | | | |
| MmsCcpp | List of preferred languages. The | Closed | Literal | “en”, |
| Accept | first element in the list should be | | list | “fr” |
| Language | regarded as the first choice of the | | | |
| | user. The value is a list of natural | | | |
| | languages, with each element in | | | |
| | the list being the name of a | | | |
| | language as defined in RFC1766; | | | |
| | Tags for the Identification of | | | |
| | Languages; March 1995; | | | |
| | (http://www.ietf.org/rfc/rfc1766.txt) | | | |
| MmsCcpp | List of transfer coding which the | Closed | Literal | “base64”, |
| Accept | MMS client supports. The value | | list | “quoted- |
| Encoding | is a list of transfer codings, with | | | printable” |
| | each element in the list being a | | | |
| | transfer coding name, as specified | | | |
| | in RFC2045; Multipurpose | | | |
| | Internet Mail Extensions | | | |
| | (MIME), Part One: “Format of | | | |
| | Internet Message Bodies”; | | | |
| | November 1996; | | | |
| | (http://www.ietf.org/rfc/rfc2045.txt), | | | |
| | which is registered with the | | | |
| | IANA | | | |
| MmsVersion | MMS versions supported by the | Closed | Literal | “2.0”, |
| | MMS client, transmitted as | | list | “1.3” |
| | majorVersionNumber.minorVersion | | | |
| | Number | | | |
| MmsCcpp | Indicates whether the MMS client | Closed | Boolean | “Yes”, |
| Streaming | has a streaming capability | | | “No” |
| Capable | | | | |
| MmsSmilBase | One or more basic sets of SMIL | Closed | Literal | “SMIL- |
| Set | (Synchronized Multimedia | | list | CONF-1-2” |
| | Integration Language) modules | | | |
| | which the client supports. “SMIL- | | | |
| | CONF-1-2” | | | |
| | identifies the SMIL basic set and | | | |
| | associated restrictions, as defined | | | |
| | in | | | |
| | OMA-MMS-CONF-v1_2-20030929- | | | |
| | C; Open Mobile Alliance; | | | |
| | MMS Conformance Document | | | |
| | 1.2; Candidate Version 16 | | | |
| | Sep. 2003. | | | |
| | Predefined values for basic sets, | | | |
| | as defined in 3GPP TS 26.234 | | | |
| | version 5.4.0, Release 5, Third | | | |
| | Generation Partnership Project; | | | |
| | Transparent end-to-end Packet | | | |
| | Switched Streaming Service | | | |
| | (PSS); Protocols and Codecs, | | | |
| | may also be used (for example | | | |
| | “SMIL-3GPP-R4” and “SMIL- | | | |
| | 3GPP-R5”). | | | |
| MmsContent | List of supported MM content | Closed | Literal | “TX”, “IB”, |
| Class | classes | | list | “IR”, “VB”, |
| | TX = Text | | | “VR” |
| | IB = Image Basic | | | |
| | IR = Image Rich | | | |
| | VB = Video Basis | | | |
| | VR = Video Rich | | | |
| Mms | Request for MMS proxy relay not | Closed | Boolean | “Yes”, |
| Suppress | to carry out content adaptation | | | “No” |
| Content | | | | |
| Adaptation | | | | |
| Mms | Request that the MMS Proxy | Closed | Boolean | “Yes”, |
| Suppress | relay does not carry out any | | | “No” |
| Content | contact adaptation when MMS | | | |
| Adaptation | is used as the carrier | | | |
| Applic | | | | |

In another embodiment, a communication terminal profile which is transmitted from a communication terminal to an MMS relay/server is refined as shown in Table 4. In this case the communication terminal profile has an XML attribute which is new in comparison to OMA-MMS-CTR-v1_{—}2-20030916-C; Open Mobile Alliance, MMS Client Transactions 1.2; Candidate Version 16 Sep. 2003; (http://member.openmobilealliance.org) entitled MmsSuppressContentAdaptationApplic by means of which it is possible to inform the MMS relay/server that content adaptation should not be carried out in the MMS relay/server when MMS multimedia messages are being used for transmission of application data by an application which is installed in that communication terminal.

TABLE 5

| | | | | |
|---|---|---|---|---|
| | | | | Example |
| Attribute | Description | Resolution rule | Type | Value |

Component: MmsCharacteristics

| | | | | |
|---|---|---|---|---|
| MmsMax | Maximum size of the multimedia | Closed | Number | 20480 |
| Message | message in bytes | | | |
| Size | | | | |
| MmsMax | Maximum size of an image in units of | Closed | Literal | “80 × 60” |
| Image | pixels (horizontal × vertical) | | | |
| Resolution | | | | |
| MmsCcpp | List of supported content types, | Closed | Literal | “image/ |
| | transmitted as MIME types | | list | jpeg”, |
| | | | | “audio/ |
| | | | | wav”, |
| | | | | “video/ |
| | | | | mpeg-4” |
| MmsCcpp | List of character sets which the MMS | Closed | Literal | “US- |
| Accept | client supports. Each element in the | | list | ASCII”, |
| CharSet | list is the name of a character set | | | “ISO- |
| | which is registered with the IANA | | | 8859-1” |
| | (Internet Assigned Numbers | | | |
| | Authority) | | | |
| MmsCcpp | List of preferred languages. The first | Closed | Literal | “en”, |
| Accept | element in the list should be regarded | | list | “fr” |
| Language | as the first choice of the user. The | | | |
| | value is a list of natural languages, | | | |
| | with each element in the list being the | | | |
| | name of a language as defined in | | | |
| | RFC1766; Tags for the Identification | | | |
| | of Languages; March 1995; | | | |
| | (http://www.ietf.org/rfc/rfc1766.txt) | | | |
| MmsCcpp | List of transfer coding which the MMS | Closed | Literal | “base64”, |
| Accept | client supports. The value is a list of | | list | “quoted- |
| Encoding | transfer codings, with each element in | | | printable” |
| | the list being a transfer coding name, | | | |
| | as specified in RFC2045; | | | |
| | Multipurpose Internet Mail Extensions | | | |
| | (MIME), Part One: “Format of Internet | | | |
| | Message Bodies”; November 1996; | | | |
| | (http://www.ietf.org/rfc/rfc2045.txt), | | | |
| | which is registered with the IANA | | | |
| MmsVersion | MMS versions supported by the MMS | Closed | Literal | “2.0”, |
| | client, transmitted as | | list | “1.3” |
| | majorVersionNumber.minorVersionNumber | | | |
| MmsCcpp | Indicates whether the MMS client has | Closed | Boolean | “Yes”, |
| Streaming | a streaming capability | | | “No” |
| Capable | | | | |
| MmsSmilBase | One or more basic sets of SMIL | Closed | Literal | “SMIL- |
| Set | (Synchronized Multimedia Integration | | list | CONF-1-2” |
| | Language) modules which the client | | | |
| | supports. “SMIL-CONF-1-2” | | | |
| | identifies the SMIL basic set and | | | |
| | associated restrictions, as defined in | | | |
| | OMA-MMS-CONF-v1_2-20030929-C; | | | |
| | Open Mobile Alliance; MMS | | | |
| | Conformance Document 1.2; | | | |
| | Candidate Version 16 Sep. | | | |
| | 2003. | | | |
| | Predefined values for basic sets, as | | | |
| | defined in 3GPP TS 26.234 version | | | |
| | 5.4.0, Release 5, Third Generation | | | |
| | Partnership Project; Transparent | | | |
| | end-to-end Packet Switched Streaming | | | |
| | Service (PSS); Protocols and Codecs, | | | |
| | may also be used (for example “SMIL- | | | |
| | 3GPP-R4” and “SMIL-3GPP-R5”). | | | |
| MmsContent | List of supported MM content classes | Closed | Literal | “TX”, “IB”, |
| Class | TX = Text | | list | “IR”, “VB”, |
| | IB = Image Basic | | | “VR” |
| | IR = Image Rich | | | |
| | VB = Video Basis | | | |
| | VR = Video Rich | | | |
| Mms | Request for MMS proxy relay not to | Closed | Boolean | “Yes”, |
| Suppress | carry out content adaptation | | | “No” |
| Content | | | | |
| Adaptation | | | | |
| Mms | List of applications on the terminal | Closed | Literal | “GameXY”, |
| Supported | which can and/or wish to use MMS | | list | “share |
| Applics | as the transport medium. | | | prices”, |
| | | | | “Application |
| | | | | example” |

In another embodiment, a communication terminal profile which is transmitted from a communication terminal to an MMS relay/server is refined as shown in Table 5. In this case, the communication terminal profile has an XML attribute which is new in comparison to OMA-NMS-CTR-v1_{—}2-20030916-C; Open Mobile Alliance, MMS Client Transactions 1.2; Candidate Version 16 Sep. 2003; (http://member.openmobilealliance.org) entitled MmsSuportedAppplics, which can be used to indicate to the MMS relay/server a list of applications (application identification) which are installed on that communication terminal and (at present) use MMS as the transport medium (or in principle could use it, that is to say possibly intend to use it). If appropriate, the MMS relay/server can use this information to suppress contact adaptation if it intends to send a multimedia message (MM) in which the application identification and/or the application address match/matches the application identification signaled by the terminal in accordance with Table 5.

Tables 2 to 5 show text coding of attributes in accordance with the UA Prof Standard. According to OMA-WAP-UAProf-v1_{—}1-20021212-C; Open Mobile Alliance; User Agent Profile 1.1; Candidate Version 12-12-2002; (http://member.openmobilealliance.org), a binary notation is also possible, in which all of the text attributes are allocated binary tokens. In another embodiment a communication terminal profile is used which has been binary-coded in this way and complies with the UA Prof Standard.

1-13. (canceled)

14. A communication system comprising:
a communication terminal; and
a server,
wherein the communication terminal has a signaling device which is configured to transmit to the server an information element which specifies whether at least one application installed on the communication terminal uses Multimedia Messaging Service as a transport medium for transmission of data, and
wherein the server has a control device which is configured to carry out a control action as a function of the transmitted information element.

15. The communication system as claimed in claim 14, wherein the server comprises:
a transmission apparatus which is configured to transmit messages to the communication terminal; and
a conversion device which is configured to convert messages to be transmitted to the communication terminal,
wherein the control action is an activation or a deactivation of a conversion by the conversion device of messages to be transmitted by the transmission apparatus of the server to the communication terminal.

16. The communication system as claimed in claim 15, wherein the control action further comprises a determination of which messages to be transmitted by the transmission apparatus of the server to the communication terminal must be converted by the conversion device.

17. The communication terminal as claimed in claim 16, wherein the conversion device is configured to convert messages which are to be transmitted to the communication terminal by the transmission apparatus using a multimedia transmission protocol.

18. The communication terminal as claimed in claim 15, wherein the conversion device is configured to convert messages which are to be transmitted to the communication terminal by the transmission apparatus using a multimedia transmission protocol.

19. The communication system as claimed in claim 18, wherein the multimedia transmission protocol is the transmission protocol for the Multimedia Messaging Service.

20. The communication system as claimed in claim 15, wherein the signaling device is configured to transmit the information element to the server using a multimedia transmission protocol.

21. The communication system as claimed in claim 15, wherein the signaling device is configured to transmit the information element using a profile of the communication terminal.

22. The communication system as claimed in claim 14, wherein the signaling device is configured to transmit the information element to the server using a multimedia transmission protocol.

23. The communication system as claimed in claim 22, wherein the multimedia transmission protocol is the transmission protocol for the Multimedia Messaging Service.

24. The communication system as claimed in claim 22, wherein the signaling device is configured to transmit the information element using a profile of the communication terminal.

25. The communication system as claimed in claim 14, wherein the signaling device is configured to transmit the information element using a profile of the communication terminal.

26. The communication system as claimed in claim 25, wherein the profile complies with the UA-Prof Standard.

27. A method for controlling a communication system comprising a communication terminal and a server, the method comprising:
the communication terminal transmitting an information element, which specifies whether at least one application installed on the communication terminal uses Multimedia Messaging Service as a transport medium for transmission of data, to the server; and
the server carrying out a control action as a function of the transmitted information element.

28. A server for a communication system having a communication terminal, the server comprising a control device which is configured to carry out a control action as a function of an information element which is transmitted by the communication terminal, the information element specifying whether at least one application installed on the communication terminal uses Multimedia Messaging Service as a transport medium for transmission of data.

29. A method for operating a server in a communication system having a communication terminal, the method comprising the server:
carrying out a control action as a function of an information element which is transmitted by the communication terminal; and
specifying whether at least one application installed on the communication terminal uses Multimedia Messaging Service as a transport medium for transmission of data.

30. A communication terminal in a communication system having a server, wherein the communication terminal comprises a signaling device which is configured to transmit an information element which specifies whether at least one application installed on the communication terminal uses Multimedia Messaging Service as a transport medium for transmission of data, to the server.
